(19) United States
(12) Patent Application Publication
(10) Pub. No.: US 2001/0018742 A1
(43) Pub. Date: Aug. 30, 2001

(54) Content distribution system, content distribution method, content distribution status monitoring apparatus and method, and content using apparatus and method

(76) Inventor: Jun Hirai, Tokyo (JP)

Correspondence Address: LERNER, DAVID, LITTENBERG,, KRUMHOLZ & MENTLIK, 600 SOUTH AVENUE WEST, WESTFIELD, NJ, 07090, US

(21) Appl. No.: 09/764,602

(22) Filed: Jan. 18, 2001

(30) Foreign Application Priority Data
Jan. 20, 2000 (JP) P2000-014195

(51) Int. Cl. H04L 9/32; G06F 11/30; G06F 12/14

(52) U.S. Cl. 713/193

(57) ABSTRACT

In order to appropriately manage or monitor the distribution status of content and to accurately impose a royalty based on use of the content, a content distribution system includes a monitoring apparatus for issuing authentication information indicating a consent to use the content and for monitoring the distribution of the content. The distribution system also includes a distribution apparatus for distributing the content via a predetermined distribution path with the authentication information attached thereto. The authentication information includes time identification information showing the current time and distributor identification information assigned to the distribution apparatus. The monitoring apparatus obtains the content being distributed in the distribution path, and can determine the validity of the distributed content based on whether the authentication information is attached to the content.

### BACKGROUND OF THE INVENTION

The present invention relates to content distribution techniques for distributing or providing content among remote locations, and in particular, relates to content a distribution technique for distributing or providing content to a large number of people, for example, in the form of broadcast waves and network transfer. More particularly, the present invention relates to content distribution techniques for a content creator, etc., to securely distribute or provide content having predetermined use rights, including copyrights, such as for music, video, etc., and in particular, relates to a content distribution technique for owners of content rights to distribute or provide content or to appropriately manage or monitor distribution status.

A copyright is a relatively exclusive property right capable of being used for authored material and is one of what are commonly called “intangible property rights”. The “authored materials” referred to herein are those in which thoughts or feelings are expressed in a creative manner and includes materials which belong to the fields of the arts, sciences, fine arts, or music. A copyright is protected by, for example, copyright acts enacted by individual countries and by international treaties, such as the Berne Convention or the Universal Copyright Convention.

It is quite rare for a copyright to be asserted by the copyright owner himself, and it is usual for the copyright owner to consent to the use of the copyright by another person in exchange for a fixed payment. For example, a record company having copyrights on music content such as musical pieces can demand from broadcasting stations which broadcast music content and from content distribution dealers, copyright royalties corresponding to the number of times the content is used.

In recent years, information processing and information communication technologies have made rapid progress, and internationalization has advanced remarkably in the cultural and economical fields. In such a social environment, the situation concerning copyrights is constantly changing. It is said that the history of copyright protection dates from the invention of printing technology at around the middle of the fifteenth century. At the present time, all data and content are being digitized, so that they can be handled on computer systems, and as a consequence of this, duplication of copyrighted material is becoming progressively easier. Therefore, it is necessary to assist authorized use of copyrighted material and to eliminate unauthorized use thereof from the viewpoint of information technology, and to expand the protection of copyrights.

In the digital content world, as one means for stopping illegal copying, a technique called “digital watermarking” or “data hiding” is available. The “digital watermarking” means that information is embedded into content such as images, music, etc., in a barely visible or barely audible form. For example, as a result of embedding copyright information by digital watermarking, the watermark, that is, the copyright information, can be isolated when the content is extracted at a later time, so that the data distribution channel and the presence or absence of a use right can be ascertained.

For example, in the music record industry and in the broadcast industry, attempts have been considered in which use of authored material is automatically managed by embedding an ISRC (International Standard Recording Code), which is identification information provided uniquely for each musical piece, as copyright information, into music content.

Between music record companies as copyright owners and broadcasting stations as copyright users, for example, a contract is signed such that the copyright royalty is paid in an amount corresponding to the number of times each musical piece is broadcast. Therefore, it is possible for the music record company (or a monitoring company entrusted by a record company) to count the number of times each musical piece is used on the basis of the appearance of the ISRC by receiving the broadcast wave and decrypting the embedded digital watermark. Furthermore, even if the broadcasting station does not accurately or honestly declare the copyright royalty, it would be possible for the music record company to reveal an erroneous declaration on the basis of the count value and to impose a penalty, such as canceling a copyright-use contract, as necessary.

In order to thoroughly stop copyright infringement by utilizing the ISRC, it is desired that an ISRC be embedded in each musical piece at the time the music content is stored (that is, manufactured) on a storage medium, such as a CD (Compact Disc).

However, dependence on the above-described method would make it impossible to track or monitor use of music content played back from a conventional CD which existed before digital watermarks were embedded. Furthermore, it is almost impossible to replace all existing content with new content having digital watermarks.

In addition, in order to add digital watermarks into all content, a data field of 60 bits is required only for music, causing the overall record length to be increased considerably.

### SUMMARY OF THE INVENTION

The present invention has been achieved in view of the above-described objects. An object of the present invention is to provide a superior content distribution technique which is capable of distributing or providing content to a large number of people, for example, in the form of broadcast waves and network transfer.

Another object of the present invention is to provide a superior content distribution technique which is capable of securely distributing or providing content having a predetermined use right, including copyright, such as music, video, etc.

Another object of the present invention is to provide a superior content distribution technique in which it is possible for the owner of rights in content to appropriately manage or monitor the distribution or provision status of the content, and to accurately impose a royalty for use of the content.

Another object of the present invention is to provide a superior content distribution technique which is capable of appropriately managing or monitoring the distribution or provision status of content with respect to content played back from a recording medium which previously had been distributed.

To achieve the above-described objects, according to a first aspect of the present invention, there is provided a system for distributing content owned by a predetermined right owner, comprising: a monitoring apparatus operable to monitor the distribution of the content by issuing authentication information indicating a consent to use the content; and a distribution apparatus operable to distribute the content with the authentication information attached thereto via a predetermined distribution path.

The monitoring apparatus referred to herein is an apparatus which is operated, for example, by a copyright owner having a copyright on the content, or by a person who is entrusted by the copyright owner with the business of monitoring the use of the content. In contrast, the distribution apparatus is an apparatus which is operated by a dealer who is entrusted with a consent to use the content by the copyright owner. It is preferable that the monitoring apparatus and the distribution apparatus be interconnected by a secure transmission medium, such as a dedicated line, so that authentication information and other various types of information (to be described later) may be exchanged securely.

In an embodiment of the invention, content is distributed by a broadcasting station as a content distribution dealer using broadcast waves. However, it should be understood that the distribution referred to in the present invention is not limited to “broadcasts”, but also includes, for example, network broadcasts via a LAN (Local Area Network) or the Internet, and content distribution via various types of storage media, such as a CD (Compact Disc), MO (Magneto-optical Disc), or DVD (Digital Versatile Disc).

It is possible for the monitoring apparatus to obtain content being distributed via the predetermined distribution path and to determine the validity of the content distribution operation based on whether the authentication information is attached to the content.

The authentication information which is issued by the monitoring apparatus may include time identification information showing the current time and distributor identification information assigned to the distribution apparatus.

The monitoring apparatus may issue an encryption key in addition to the authentication information. In such a case, the distribution apparatus can distribute the content with the attached authentication information encrypted using the encryption key received from the monitoring apparatus via a predetermined distribution path. Therefore, it is possible to appropriately prevent the authentication information attached to the content from being falsified in the distribution path.

The distribution apparatus may embed authentication information into the content using a digital watermarking technique. Alternatively, the distribution apparatus may embed authentication information into a content distribution signal using a digital watermarking technique. As a result of using a digital watermarking technique, ordinary viewers and listeners who receive a broadcast wave need not be aware of the presence of the authentication information. In particular, in the latter case, since the authentication information need not be embedded in the content itself, the authentication information can be easily embedded in music content as well as played back from a storage medium which has already been distributed.

Normally, each content has specific content identification information. For example, in the case of music content, an ISRC (International Standard Recording Code), which can be identified anywhere in the world, is assigned to each musical piece.

It is possible for the distribution apparatus to store the distribution history for each content distributed via the predetermined distribution path in association with its specific content identification information.

In the monitoring apparatus, identification information by which the distribution history can be addressed may be contained in the authentication information. In this case, time identification information need not be contained in the authentication information.

Furthermore, it is possible for the distribution apparatus to extract only the history information associated with specific content by masking the distribution history with a predetermined filter and to transfer it to a monitoring dealer such as a monitoring apparatus. In the case of the above-described ISRC, it is formed of five groups 1 to 5. Of these, three digits corresponding to group 3 indicate a first owner code. By performing filtering using this group 3 as a mask, it is possible to extract only the distribution history information relating to the contents of a specific copyright owner. In contrast, on the monitoring apparatus side, the distribution status of each content can be managed on the basis of the distribution history information. For example, it is possible to charge an accurate copyright royalty, corresponding to the number of times the content has been used, to the distribution apparatus, that is, the broadcasting station.

According to a second aspect of the present invention, there is provided a method for distributing content owned by a predetermined right owner, comprising: issuing to a distributor authentication information indicating a consent to use the content; distributing the content via a predetermined distribution path with the authentication information attached thereto; and monitoring the distribution of the content in the predetermined distribution path.

The above-described monitoring step can obtain content being distributed in the predetermined distribution path and determine the validity of the content distribution operation based on whether the authentication information is attached to the content.

The above-described issuing step may issue, as the authentication information, time identification information showing the current time and distributor identification information assigned to the distributor of the content.

Furthermore, the above-described issuing step may issue an encryption key in addition to the authentication information. In this case, the distributing step can distribute the content with the attached authentication information encrypted using the encryption key, making it possible to appropriately prevent the authentication information from being falsified.

The distributing step may embed the authentication information into the content using a digital watermarking technique. Alternatively, the distributing step may embed the authentication information into a distribution signal of the content using a digital watermarking technique.

Each content usually has specific content identification information. In such a case, it is possible to provide a further step of storing a distribution history for each content distributed via the predetermined distribution path in association with its respective content identification information. Furthermore, identification information by which the distribution history can be addressed may be contained in the authentication information. In this case, time identification information need not be contained in the authentication information. It is possible to provide a still further step of extracting only the history information associated with specific content by masking the distribution history with a predetermined filter, as well as a step of managing the distribution of each content based on the distribution history.

According to a third aspect of the present invention, there is provided an apparatus or method for monitoring the use of content owned by a predetermined right owner, wherein a device is provided to issue to a content user authentication information indicating a consent to use the content.

The authentication information may include at least time identification information showing the current time and distributor identification information assigned to the distributor.

An encryption key may be issued to the content user in addition to the authentication information.

A unit or step may be provided to obtain the content being used and to check the presence or absence of the authentication information.

Another unit or step may be provided to manage a use status of the content based on the content use history of the content user.

According to a fourth aspect of the present invention, there is provided an apparatus or method for using content after receiving a consent to use from a predetermined right owner, comprising a receiver operable to receive or a step of receiving authentication information indicating the consent to use; and a use unit operable to use or a step of using the content with the received authentication information attached thereto.

The use unit or using step can distribute the content and the attached authentication information via a predetermined distribution path. As a result, the validity of the content can be checked based on whether the authentication information is contained in the content to be used in the distribution path.

The authentication information can contain at least time identification information showing the current time and user identification information assigned to the user.

The receiver or receiving step may receive an encryption key in addition to the authentication information, and the use unit or using step may use the content with the attached authentication information encrypted using the encryption key. As a result, it is possible to appropriately prevent the authentication information from being falsified in the distribution path.

The use unit may embed authentication information into the content by using a digital watermarking technique. Alternatively, the use unit or using step may embed authentication information into a content distribution signal using a digital watermarking technique.

Each content usually has specific content identification information. Therefore, a storage unit or storage step may be provided to store a use history for each content used by the use unit or using step in association with its specific content identification information. Furthermore, identification information by which the use history can be addressed may be contained in the authentication information. In this case, time identification information need not be contained in the authentication information.

It is possible to extract only history information associated with specific content by masking the stored use history with a specific filter. It is also possible to manage the use status of each content based on the stored use history.

The above and further objects, aspects and novel features of the invention will become more fully apparent from the following detailed description when read in conjunction with the accompanying drawings.

### BRIEF DESCRIPTION OF THE DRAWINGS

FIG. 1 is a diagram schematically showing the configuration of a content distribution system 100 according to an embodiment of the present invention;

FIG. 2 is a diagram schematically showing another configuration of the content distribution system 100 according to the embodiment of the present invention;

FIG. 3A is a schematic representation of a state in which authentication information which is embedded by digital watermark is encrypted, showing a state in which authentication information composed of a time ID and a broadcasting station ID is encrypted;

FIG. 3B is a schematic representation of a state in which authentication information which is embedded by digital watermark is encrypted, showing a state in which a time ID in the form of plain text is attached to the encrypted authentication information; and

FIG. 4 is a diagram showing in detail the configuration of the content distribution system 100 according to the embodiment of the present invention.

### DETAILED DESCRIPTION OF PREFERRED EMBODIMENTS

An embodiment of the present invention will be described below with reference to the attached drawings.

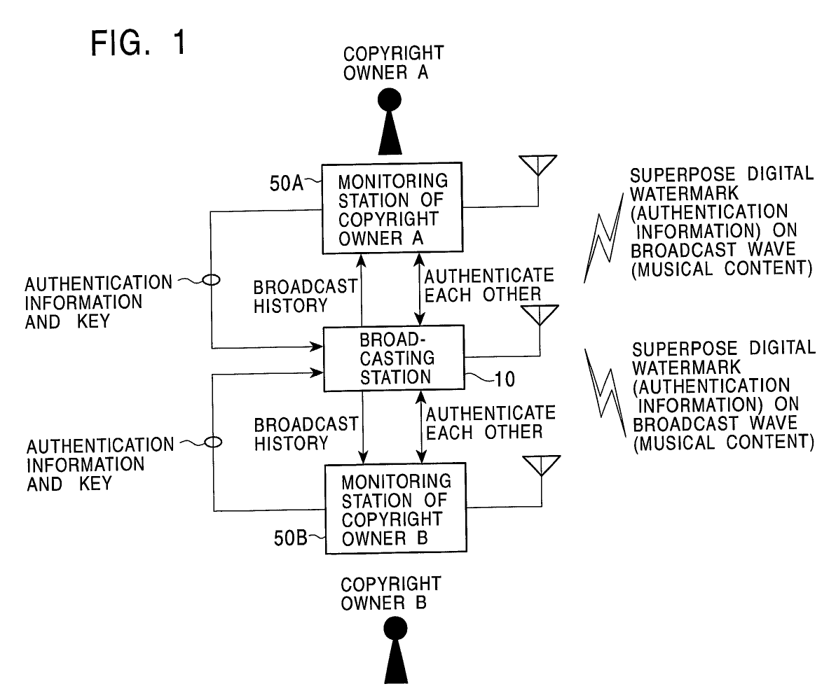

FIG. 1 schematically shows the concept of a content distribution system 100 according to the present invention. As shown in FIG. 1, the content distribution system 100 comprises a broadcasting station 10 and a monitoring station 50.

The monitoring station 50 is operated by the copyright owner or by an organization or company which is entrusted by the copyright owner so as to track or monitor the use of authored material. The copyright owner may be a music record company which stores music content in recording media, such as CDs, and which sells and distributes them. Also, the monitoring station 50 monitors each content, that is, each piece of authored material, which is broadcast by the broadcasting station, and the detailed procedure thereof will be described later.

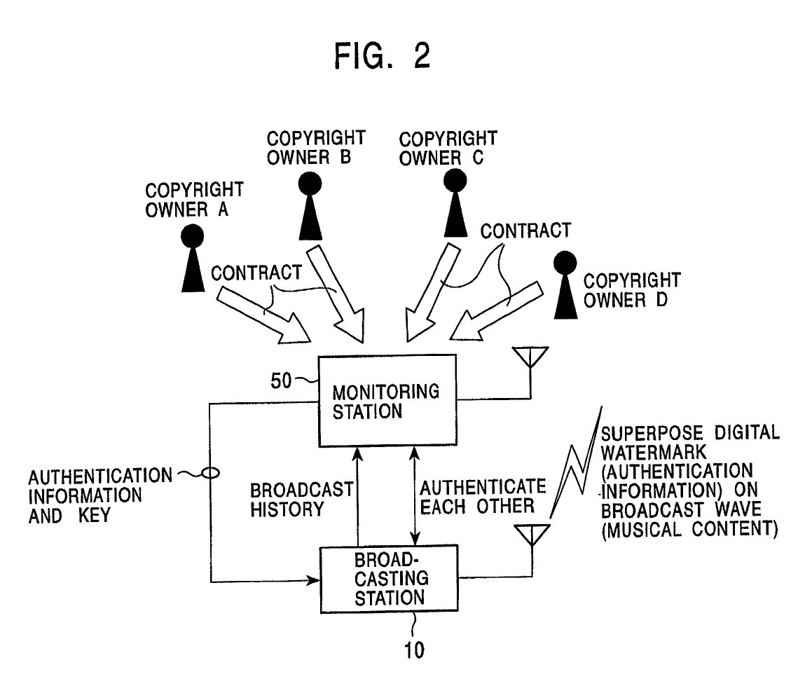

In the example shown in FIG. 1, a monitoring station is provided for each copyright owner. However, as shown in FIG. 2, a single monitoring station may provide monitoring services for plural copyright owners.

Also, in actuality, there are a plurality of broadcasting stations, and the copyright owner must monitor its own authored material, that is, the content use status, for all the broadcasting stations. The copyright owner may set up a monitoring station for each broadcasting station, or a single monitoring station may handle plural broadcasting stations.

In the following, for the sake of convenience, a description is given by using, as an example, a case in which one monitoring station 50 monitors one broadcasting station 10.

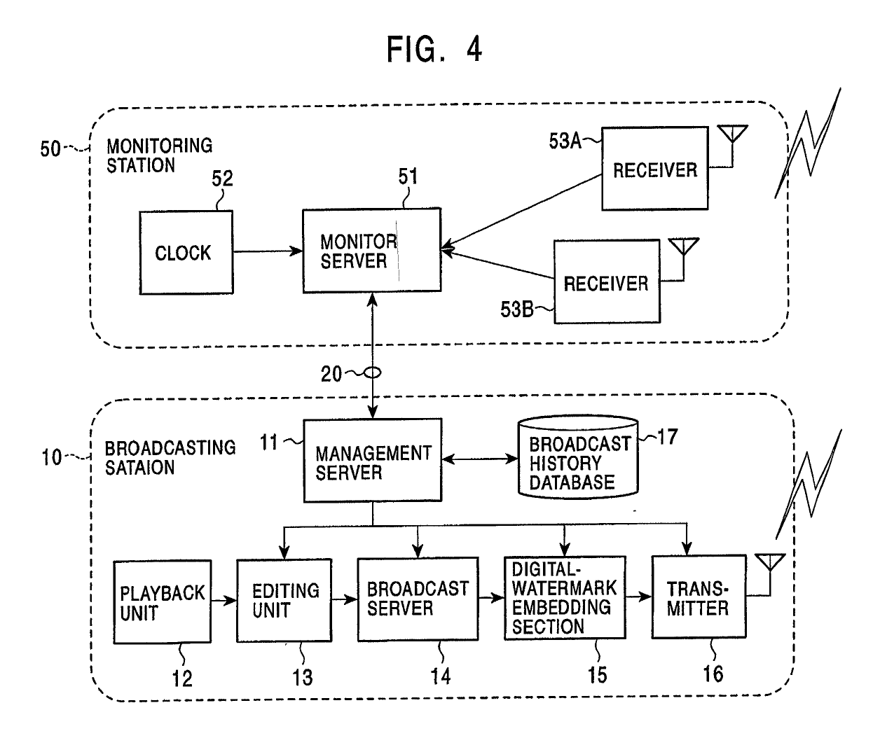

The broadcasting station 10 and the monitoring station 50 are interconnected with each other via a secure transmission line, such as a dedicated line 20 (FIG. 4), and what is commonly called “impersonation” can be blocked by causing a predetermined authentication procedure to be performed.

During the period in which authentication is being established between them, the monitoring station 50 supplies to the broadcasting station 10 broadcasting station identification information (hereinafter referred to as a “broadcasting station ID”), time identification information (hereinafter referred to as a “time ID”), and an encryption key. In the following, the information composed of the combination of the broadcasting station ID and the time ID is called “authentication information”. The authentication information enables authentication of a use consent for content.

However, the time identification information need not necessarily be contained in the authentication information. For example, the time identification information may be replaced with other identification information by which each record of the broadcast information (to be described later) stored in the broadcasting station can be addressed.

[Broadcasting station ID]: [Time ID]: [Key]

The broadcasting station ID is a proof such that the monitoring station 50 which handles content use for the copyright owner has authenticated the broadcasting station 10, and further, has consented to the use of the authored material. When the monitoring station 50 consents to the use of authored material in a constant or fixed manner, the monitoring station 50 need transfer the broadcasting station ID to the broadcasting station 10 only once after authentication has been established. When, on the other hand, use of authored material is consented to only in a time-limited manner, it is necessary to transfer a new broadcasting station ID to the broadcasting station 10 each time use of the authored material is newly consented to during the period in which authentication has been established. The time-limited broadcasting station ID can be managed in combination with, for example, the time ID (to be described later). In the case of the implementation of the latter case, the monitoring station 50 can supply a consent for using the authored material for each broadcast program or for each broadcast time zone.

The time ID is identification information which is uniquely related to the current time, and, for example, may be the time data itself. When the provision of the time ID by the monitoring station 50 and the content distribution in the broadcasting station 10, that is, a program broadcast, are being performed in real time (or when the time lag between the provision of the time ID and the content distribution is a fixed value), the time ID can specify the broadcast time of a program and the broadcast content itself.

The key is an encryption key which is used to encrypt predetermined authentication information composed of the broadcasting station ID and the time ID on the broadcasting station 10 side and to further decrypt the encrypted information in the monitoring station 50. When one key is used in a fixed manner, the monitoring station 50 need transfer the key only once to the broadcasting station 10 after authentication has been established. However, in order to prevent reuse of a key, it is necessary for the monitoring station 50 to change the key as time elapses and to transfer the key to the broadcasting station 10 each time the key is changed. In the latter case, the key can be recognized as a time-related function key (t). The key (t) may be managed in association with the time ID.

For the key used herein, either a common key encryption method in which the same key is used at the time of encryption and decryption or a public key encryption method in which a secret key and a public key are formed in combination may be used. However, in the following description, for the sake of convenience, a common key is used.

On the broadcasting station 10 side, a broadcast wave is generated in which the authentication information received from the monitoring station 50 is superposed onto the distribution content, and the broadcast wave is transmitted that is, broadcast, to each receiver.

The authentication information, as described above, is composed of the combination (for example, each ID is bit-coupled) of the broadcasting station ID and the time ID. When a broadcast is performed in real time with authentication by the broadcasting station 10, the time ID may be omitted. However, on the receiver side, in order to specify the source of the broadcast content stored on a recording medium, that is, the copyright owner of the authored material, it is preferable that the time ID be used as a part of the authentication information.

In realizing the present invention, the form in which the authentication information is attached to the broadcast content does not particularly matter. For example, the broadcasting station ID and the time ID may be superposed on each other by using a digital watermarking technique. In such a case, the authentication information may be superposed on either the content itself or on the broadcast wave. As a result of using a digital watermarking technique, it is not at all necessary for receivers, such as ordinary viewers and listeners, to be concerned with the presence of the authentication information.

When digital watermarking is performed on a broadcast wave rather than on the original content, the present invention can be applied by merely changing the equipment of the broadcasting station. Also, since the digital watermark need not be provided in the content itself, it is possible to appropriately perform copyright management on content which originates from a recording medium such as a CD, which has already been in common use.

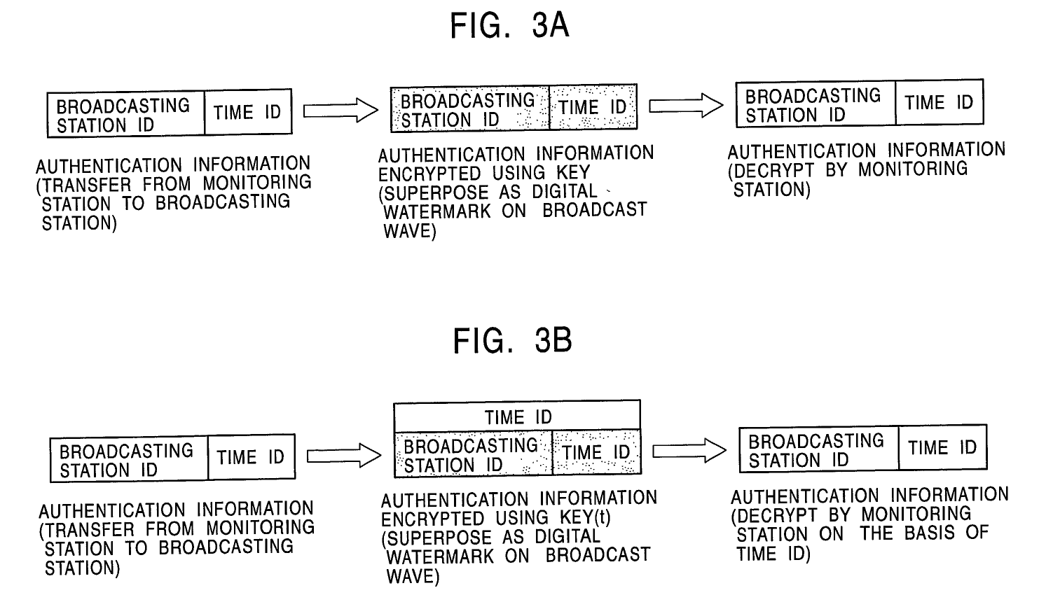

Furthermore, in order that the authentication information which is embedded by digital watermarking be protected against falsification, the authentication information composed of the broadcasting station ID and the time ID may be encrypted (see FIG. 3A) using the key received from the monitoring station 50, after which the authentication information is superposed onto the broadcast wave. In such a case, it is necessary for the monitoring station 50 to decrypt the authentication information. Furthermore, when the key is a time-related function key (t), the monitoring station 50 must determine which key should be used for decryption. Therefore, the information (see FIG. 3B) in which a time ID in the form of plain text is further attached to the encrypted authentication information may be superposed onto the broadcast wave. It is possible for the monitoring station 50 to determine the applicable key (t) on the basis of the time ID.

The broadcasting station 10 stores the broadcast history information about the contents which are broadcast by the broadcasting station 10 itself so as to manage a database. For the database, it is preferable that records be created for each broadcast content. Each record has fields for storing each of at least a content ID, a time ID, and a broadcasting station ID, as shown below:

[Content ID]: [Time ID]: [Broadcasting station ID]

The content ID referred to herein is information by which a broadcast content can be uniquely identified. For example, in the case of a music content, an ISRC which is defined in the ISO (International Organization for Standardization) 3901 can be used. Furthermore, in the case of a commercial, an ISCI can be used. In addition to these, a tag affixed to a sequence may be used as content ID.

The history information which is formed into a database is transferred to the monitoring station 50 as necessary (for example, in response to a request). Alternatively, the monitoring station 50 can access the history information database independently.

FIG. 4 shows in more detail the configuration of the content distribution system 100 according to the embodiment of the present invention.

As shown in FIG. 4, the monitoring station 50 comprises a monitor server 51, a clock 52 for providing the current time, and one or more receivers 53A and 53B for receiving the broadcast wave of the broadcasting station 10. It is assumed that the monitor server 51 is connected to each section by a secure communication method, such as encrypted communication.

The monitor server 51 is connected to a management server 11 in the broadcasting station 10 through a secure transmission line, such as the dedicated line 20, so that authentication can be established between the monitoring station 50 and the broadcasting station 10 in accordance with a predetermined procedure. As a result of establishing authentication, the monitor server 51 can supply authentication information, such as the broadcasting station ID and the time ID, and the key to the broadcasting station 10.

The broadcasting station 10 comprises the management server 11 for centrally managing the operations within the station, a playback unit 12, an editing unit 13, a broadcast server 14, a digital-watermark embedding section 15, a transmitter 16, and a broadcast history database 17. It is assumed that the management server 11 is connected to each section by a secure communication method, such as encrypted communication.

The playback unit 12 plays back content in media, such as music, video, announcements, etc. The editing unit 13 integrates and edits each played-back content in order to edit a broadcast content. The edited results are stored in the broadcast server 14.

The broadcast server 14 is connected to the management server 11 at all times by a secure communication method, such as encrypted communication. Thus, the broadcast history about media playback, and the broadcast content editing and recording can be securely stored in the broadcast history database 17. In the broadcast history database 17, for example, records are created for each broadcast content, and each record has fields for storing each of at least a content ID, a time ID, and a broadcasting station ID, as described earlier.

Also, the broadcast server 14 completes the editing results of the editing unit 13 in a form in which they can be distributed as broadcast waves, and outputs these at a scheduled time (for example, a broadcast time) controlled by the management server 11.

The digital-watermark embedding section 15 embeds the authentication information received from the monitor server 51 as a digital watermark. The authentication information is composed of the broadcasting station ID and the time ID. In this case, in order to prevent falsification of the authentication information, it is preferable that the authentication information be embedded after being encrypted using the key received from the monitor server 51. Furthermore, in order to improve the level of security, it is preferable that the key be changed as time elapses. In this case, in order to make it easy to determine the key used, the encrypted authentication information to which a time ID in the form of plain text is attached may be embedded (see description above and FIG. 3B).

The transmitter 16 emits a broadcast wave in which authentication information is embedded in a manner as described above. The broadcast wave, however, may be a terrestrial wave or a satellite wave, and the transmission line may be either wireless or cables. Furthermore, as a modification of the present invention, the path of the content distribution may be through a network such as a LAN (Local Area Network) or the Internet, or through a public telephone network such as PSTN (Public Switched Telephone Network) or ISDN (Integrated Services Digital Network). Furthermore, the content distribution form may be either a push type or a pull type.

The management server 11 and the monitor server 51 are connected to each other through a secure transmission line, such as a dedicated line, so that authentication can be established between the monitoring station 50 and the broadcasting station 10 in accordance with a predetermined procedure. As a result of establishing authentication, the management server 11 can supply, to the monitor server 51, history information stored in the broadcast history database 17 as necessary (for example, in response to a request) Alternatively, the monitor server 51 can access the history information database.

The broadcasting station 10 usually produces a broadcast program by using the contents of a plurality of copyright owners. Also, as shown in FIG. 1, there are cases in which one broadcasting station 10 is placed under the supervision of a plurality of monitoring stations 50 which are provided for each copyright owner. In such a case, transmitting all the records stored in the broadcast history database 17 to all the monitor stations 50A, 50B, . . . , is inefficient and irrational. The reason for this is that disclosure of the use status of the authored material to those other than the copyright owner corresponds to an invasion of privacy, and transferring of more data than is necessary increases the communication load unnecessarily. Therefore, the history information should be filtered for each copyright owner and transmitted to the appropriate monitoring station 50.

For example, an ISRC assigned to music content is formed of five groups 1 to 5. Of these, three digits corresponding to group 3 indicate a first owner code. By filtering using this group 3 as a mask, it is possible to extract only the history information relating to the contents of a specific copyright owner. In contrast, on the monitoring station 50 side, the distribution status of each content can be managed on the basis of the history information. For example, it is possible to charge an accurate copyright royalty, corresponding to the number of times the content is used, to the distribution apparatus, that is, the broadcasting station.

Next, a description is given of the processing procedure for monitoring the use status of a piece of authored material in the monitoring station 50. However, the authored material referred to herein refers to a music content used during a broadcast program in the broadcasting station 10, the user of the authored material is the broadcasting station 10, and the monitoring object is a broadcast wave emitted from the broadcasting station 10.

When the monitoring receivers 53A and 53B receive a broadcast wave, the monitoring receivers 53A and 53B decode the digital watermark in order to extract the authentication information, and transfer this to the management server 11 in a secure form.

It is possible for the management server 11 to confirm that the broadcasting station 10 is using the authored material, that is, a content, with authorization based on the fact that the authentication information is contained in the broadcast wave. When the authentication information is not contained in the content, since this means that the broadcasting station 10 is using the authored material without authorization, a penalty may be imposed on the broadcasting station 10. The penalty may be an action for depriving or suspending the content use right for a predetermined period.

Furthermore, embedding the authentication information encrypted using a key by the broadcasting station 10 makes it possible to determine whether or not there has been impersonation in the distribution path. That is, when the authentication information cannot be decoded using a key corresponding to the broadcast content, it can be determined that impersonation has occurred. Also, when authentication information in a form such as that shown in FIG. 3B is embedded, a case in which the time ID attached in plain text does not match the time ID obtained by decoding the authentication information can be determined as being a case of impersonation.

The management server 11 monitors the system from the playback unit 12 up to the transmitter 16, and confirms that the content is not falsified, after which the management server 11 requests the monitor server 51 to issue a key. As a result, only the broadcast history information whose security has been confirmed is stored in the broadcast history database 17.

The present invention has thus been described in detail while referring to a specific embodiment. It is self-explanatory that modifications and substitutions of the embodiment may be made without departing from the spirit and scope of the present invention by a person skilled in the art.

In the above-described embodiment, an ISRC, tags affixed to a sequence, etc., are used, as a content ID for the digital watermark, but the content ID is not particularly limited thereto. For example, even if data in which a part or all of a musical piece is compressed or data in which a part of a musical piece is sampled, is used for the digital watermark, the same operational effects can be obtained.

In summary, the present invention has been disclosed in the form of exemplifications and should not be construed as being limited thereby. In order to determine the gist of the present invention, the claims should be taken into consideration.

As has thus been described in detail, according to the present invention, it is possible to provide a superior content distribution technique which is capable of distributing or providing content to a large number of people, for example, in the form of broadcast waves and network transfer.

According to the present invention, it is possible to provide a superior content distribution technique which is capable of securely distributing or providing content having a predetermined use right, including copyright, such as music, video, etc.

According to the present invention, it is possible to provide a superior content distribution technique in which it is possible for the right owner of content to appropriately manage or monitor the distribution or provision status of the content.

According to the present invention, it is possible to provide a superior content distribution technique which is capable of appropriately managing or monitoring the distribution or provision status of content with respect to content played back from a recording medium which has already been distributed.

According to the present invention, as a result of performing digital watermarking on a broadcast wave rather than on the original content, adaptations are possible by merely changing the equipment of the broadcasting station. Furthermore, since the digital watermark need not be provided in the content itself, it is possible to appropriately perform copyright management on a content which originates from a recording medium such as a CD, which has already been in common use.

Many different embodiments of the present invention may be constructed without departing from the spirit and scope of the present invention. It should be understood that the present invention is not limited to the specific embodiment described in this specification. To the contrary, the present invention is intended to cover various modifications and equivalent arrangements included within the spirit and scope of the invention as hereafter claimed. The scope of the following claims is to be accorded the broadest interpretation so as to encompass all such modifications, equivalent structures and functions.

1. A system for distributing content owned by a predetermined right owner, comprising:
a monitoring apparatus operable to monitor the distribution of the content by issuing authentication information indicating a consent to use the content; and
a distribution apparatus operable to distribute the content with the authentication information attached thereto via a predetermined distribution path.

2. A content distribution system according to claim 1, wherein said monitoring apparatus obtains the content being distributed via said predetermined distribution path and determines the validity of the content distribution operation based on whether said authentication information is attached to the content.

3. A content distribution system according to claim 1, wherein said authentication information includes time identification information showing the current time and distributor identification information assigned to the distribution apparatus.

4. A content distribution system according to claim 1, wherein said monitoring apparatus issues an encryption key in addition to said authentication information, and said distribution apparatus distributes the content with the attached authentication information encrypted using said encryption key.

5. A content distribution system according to claim 1, wherein said distribution apparatus embeds said authentication information into the content using a digital watermarking technique.

6. A content distribution system according to claim 1, wherein said distribution apparatus embeds said authentication information into a distribution signal of the content using a digital watermarking technique.

7. A content distribution system according to claim 1, wherein each content has specific content identification information, and said distribution apparatus stores a distribution history for each content distributed via said predetermined distribution path in association with its specific content identification information.

8. A content distribution system according to claim 1, wherein each content has specific content identification information, said distribution apparatus stores a distribution history for each content distributed via said predetermined distribution path in association with its specific content identification information, and transfers only said distribution history associated with specific content by masking said distribution history with a predetermined filter.

9. A content distribution system according to claim 1, wherein each content has specific content identification information, said distribution apparatus stores a distribution history for each content distributed via said predetermined distribution path in association with its specific content identification information, and said monitoring apparatus manages the distribution status of each content based on said distribution history.

10. A content distribution system according to claim 1, wherein each content has specific content identification information, said distribution apparatus stores a distribution history for each content distributed via said predetermined distribution path in association with its specific content identification information, and said monitoring apparatus causes content identification information by which said distribution history can be addressed to be contained in said authentication information.

11. A distribution method for distributing content owned by a predetermined right owner, comprising:
issuing to a distributor authentication information indicating a consent to use the content;
distributing the content via a predetermined distribution path with the authentication information attached thereto; and
monitoring the distribution of the content in the predetermined distribution path.

12. A content distribution method according to claim 11, wherein said monitoring step includes obtaining content being distributed in the predetermined distribution path and determining the validity of the content distribution operation based on whether the authentication information is attached to the content.

13. A content distribution method according to claim 11, wherein the authentication information includes time identification information showing the current time and distributor identification information assigned to the distributor.

14. A content distribution method according to claim 11, wherein said issuing step further includes issuing an encryption key, and said distributing step distributes the content with the attached authentication information encrypted using the encryption key.

15. A content distribution method according to claim 11, wherein said distributing step embeds the authentication information into the content using a digital watermarking technique.

16. A content distribution method according to claim 11, wherein said distributing step embeds the authentication information into a distribution signal of the content using a digital watermarking technique.

17. A content distribution method according to claim 11, wherein each content has specific content identification information, said content distribution method further comprising:
storing a distribution history for each content distributed via the predetermined distribution path in association with its respective content identification information.

18. A content distribution method according to claim 11, wherein each content has specific content identification information, said content distribution method further comprising:
storing a distribution history for each content distributed via the predetermined distribution path in association with its respective content identification information; and
extracting only the distribution history associated with specific content by masking the distribution history with a predetermined filter.

19. A content distribution method according to claim 11, wherein each content has specific content identification information, said content distribution method further comprising:
storing a distribution history for each content distributed via the predetermined distribution path in association with its respective content identification information; and
managing the distribution of each content based on the distribution history.

20. A content distribution method according to claim 11, wherein each content has specific content identification information, said content distribution method further comprising:
storing a distribution history for each content distributed via the predetermined distribution path in association with its respective content identification information,
wherein the issuing step issues authentication information containing identification information by which the distribution history can be addressed.

21. An apparatus for monitoring the use of content owned by a predetermined right owner, comprising:
a device operable to issue to a distributor authentication information indicating a consent to use the content.

22. An apparatus according to claim 21, wherein said authentication information includes at least time identification information showing the current time and distributor identification information assigned to said distributor.

23. An apparatus according to claim 21, wherein said authentication information includes at least distributor identification information assigned to said distributor and identification information by which a distribution history of the content for said distributor can be addressed.

24. An apparatus according to claim 21, wherein an encryption key is issued to said distributor in addition to said authentication information.

25. An apparatus according to claim 21, wherein said authentication information is attached to content distributed based on said consent to use, said apparatus further comprising:
a unit operable to determine whether said authentication information is attached to distributed content.

26. An apparatus according to claim 21, further comprising:
a unit operable to manage a use status of the content based on a content use history of said distributor.

27. A method for monitoring use of content owned by a predetermined right owner, comprising:
issuing to a content user authentication information indicating a consent to use the content.

28. A content monitoring method according to claim 27, wherein the authentication information includes at least time identification information showing the current time and distributor identification information assigned to the content user.

29. A content monitoring method according to claim 27, wherein the authentication information includes at least distributor identification information assigned to the distributor and identification information by which a distribution history of the content for the content user can be addressed.

30. A content monitoring method according to claim 27, further comprising issuing to the content user an encryption key in addition to the authentication information.

31. A content monitoring method according to claim 27, further comprising:
using the content for which there is a consent to use with the authentication information attached thereto; and
determining whether the authentication information is attached to content being used.

32. A content monitoring method according to claim 27, further comprising:
managing a use status of the content based on a content use history of the content user.

33. An apparatus for using content after receiving a consent to use from a predetermined right owner, comprising:
a receiver operable to receive authentication information indicating the consent to use; and
a use unit operable to use the content with said authentication information attached thereto.

34. A content using apparatus according to claim 33, wherein said use unit distributes the content and said attached authentication information via a predetermined distribution path.

35. A content using apparatus according to claim 33, wherein said authentication information includes at least time identification information showing the current time and user identification information assigned to the user.

36. A content using apparatus according to claim 33, wherein said authentication information includes at least distributor identification information assigned to the distributor and identification information by which a use history of the content for the distributor can be addressed.

37. A content using apparatus according to claim 33, wherein said receiver is operable to receive an encryption key in addition to said authentication information, and said use unit uses the content with said attached authentication information encrypted using said encryption key.

38. A content using apparatus according to claim 33, wherein said use unit embeds said authentication information into the content using a digital watermarking technique.

39. A content using apparatus according to claim 33, wherein said use unit embeds said authentication information into a distribution signal of the content using a digital watermarking technique.

40. A content using apparatus according to claim 33, wherein each content has specific content identification information, said apparatus further comprising:
a storage unit operable to store a use history of each content used by said use unit in association with its specific content identification information.

41. A content using apparatus according to claim 33, wherein each content has specific content identification information, said apparatus further comprising:
a storage unit operable to store a use history for each content used by said use unit in association with its specific content identification information; and
an extraction unit operable to extract only said use history associated with specific content from said storage unit by masking said stored use history with a predetermined filter.

42. A content using apparatus according to claim 33, wherein each content has specific content identification information, said apparatus further comprising:
a storage unit operable to store a use history for each content used by said use unit in association with its specific content identification information; and
a management unit operable to manage a use status of each content based on said stored use history.

43. A method for using content after receiving a consent to use from a predetermined right owner, comprising:
receiving authentication information indicating the consent to use; and
using the content with the authentication information attached thereto.

44. A content using method according to claim 43, wherein said using step distributes the content and the attached authentication information via a predetermined distribution path.

45. A content using method according to claim 43, wherein the authentication information includes at least time identification information showing the current time and user identification information assigned to the user.

46. A content using method according to claim 43, wherein the authentication information includes at least distributor identification information assigned to the distributor and identification information by which a use history of the content for the distributor can be addressed.

47. A content using method according to claim 43, wherein said receiving step receives an encryption key in addition to the authentication information, and said using step uses the content with the attached authentication information encrypted using the encryption key.

48. A content using method according to claim 43, wherein said using step embeds the authentication information into the content using a digital watermarking technique.

49. A content using method according to claim 43, wherein said using step embeds the authentication information into a distribution signal of the content using a digital watermarking technique.

50. A content using method according to claim 43, wherein each content has specific content identification information, said method further comprising:
storing a use history for each content used in said using step in association with its specific content identification information.

51. A content using method according to claim 43, wherein each content has specific content identification information, said method further comprising:
storing a use history for each content used in said using step in association with its specific content identification information; and
extracting only the use history associated with specific content by masking the stored use history with a predetermined filter.

52. A content using method according to claim 43, wherein each content has specific content identification information, said method further comprising:
storing a use history for each content used in said using step in association with its specific content identification information; and
managing a use status of each content based on the stored use history.
